(19) United States
(12) Patent Application Publication
(10) Pub. No.: US 2010/0191995 A1
(43) Pub. Date: Jul. 29, 2010

(54) In-Band Sleep Protocol for Embedded Bus

(76) Inventors: Koby Levy, Bat-Yam (IL); Avraham Baum, Giva'at Shmuel (IL); Jerome Loisel, Mougins (FR); Kobi Leibovitch, Petah-Tiqva (IL); Yoel Boger, Shoham (IL)

Correspondence Address: TEXAS INSTRUMENTS INCORPORATED, P O BOX 655474, M/S 3999, DALLAS, TX, 75265, US

(21) Appl. No.: 12/693,402

(22) Filed: Jan. 25, 2010

Related U.S. Application Data
(60) Provisional application No. 61/147,166, filed on Jan. 26, 2009.

(51) Int. Cl. G06F 1/32

(52) U.S. Cl. 713/323

(57) ABSTRACT

A sleep protocol is provided for controlling sleep mode in a device having a receive port and a transmit port. A location is established in a map of locations in the device as a sleep/wake control location. When the device receives a command to store a sleep value in the sleep/wake control location, this indicates there is no pending traffic for the receive port. When the device also determines that there is no pending traffic on the transmit port, then the device may enter a low power sleep mode. When the device receives a command to store a wake value in the sleep/wake control location to indicate pending traffic for the receive port, it awakens from sleep mode and responds to the wake command with a reply command to indicate the receive port is ready to receive the pending traffic.

### CLAIM OF PRIORITY UNDER 35 U.S.C. 119

The present application claims priority to and incorporates by reference U.S. provisional application No. 61/147,166, (attorney docket TI-67102PS) filed Jan. 26, 2009, entitled “SlimBus Extension: In-Band Sleep Protocol.”

### FIELD OF THE INVENTION

The present invention relates to controlling sleep mode in a digital system and in particular to controlling sleep mode in modules coupled to an embedded bus.

### BACKGROUND OF THE INVENTION

Digital systems typically include several different components or modules that may perform particular tasks. When that task is not needed, system power consumption may be reduced by placing a module that is not currently needed in a low power mode. Low power mode is typically referred to as “standby” or “sleep” mode, for example, in which the module stops processing, or processes at a very low rate to conserve power. When the task is again needed, then the module is directed to wakeup and resumes processing at a normal rate. In many mobile systems, such as cell phones or personal digital assistants, the need to keep an overall low average current consumption necessitates the need to transition into low-power (“sleep”) mode while not active.

These transitions may have a relatively high occurrence rate. For example, in a cell phone, transition into sleep mode for a symbol processing module may be done while active communication is being maintained, such as in-between audio frames.

Demand for multimedia functions within mobile terminals is increasing. A key driver for unit growth and product differentiation is digital audio. Commonly used digital audio interfaces in mobile terminals such as I2S (Inter IC Sound) and pulse code modulation (PCM) are generally intended for point-to-point connection between an application processor and a single digital audio device. Typically, these interfaces only support one or two digital audio channels. As such, adding functions and digital audio channels to mobile terminals beyond those for voice communication and simple stereo music applications is very difficult without increasing the number of bus structures in the mobile terminal. Though scalable, just adding bus structures limits design flexibility and is costly in terms of pin count, package size, printed circuit board (PCB) layout area and power consumption. In addition, numerous control bus structures such as I2C (Inter-Integrated Circuit), SP (serial peripheral interface), MicroWire™, UART (universal asynchronous receive-transmit) and GPIOs (general purpose input/output), typically reside in parallel to audio buses not only for audio device control, but handling the countless low bandwidth control tasks required for lighting, haptic feedback, temperature monitoring and power sequencing, for example.

The Serial Low-power Inter-chip Media Bus (SLIMbus) is a bus standard that defines a robust, scalable, low-power, high-speed, cost-effective, two wire multi-drop interface that supports a wide range of digital audio and control solutions for mobile terminals. It may be used as a standard interface between baseband or application processors and peripheral components in mobile terminals. The SLIMbus specification was developed within the MIPI (Mobile industry Processor Interface) Alliance. SLIMbus effectively replaces many other digital audio buses such as PCM and I2S, as well as control buses such as I2C, SPI, microWire, GPIO or UART, in a mobile terminal by providing flexible and dynamic assignment of bus bandwidth between digital audio and non-audio control and data functions.

SLIMbus is implemented by a synchronous 2-wire, flexible TDM (time domain multiplex) frame structure and surrounding bus arbitration mechanisms and message structures, which taken together establish flexible and robust data connections between SLIMbus devices. Although optimized for the transport of constant-rate media streams, SLIMbus can transport various types of asynchronous data as well as control data. The SLIMbus is described in more detail in various articles, such as “An Introduction to the Mobile Industry Processor Interface (MIPI) Alliance Standard Serial Low-power Inter-chip Media Bus (SLIMbus),” Kenneth Boyce, 2009, and is incorporated by reference herein. Access to the standard itself is currently limited to MIPI Alliance members.

SLIMbus is not designed for hot-swap capability since the intended use is completely within a client terminal such as a cellular phone. However, the SLIMbus specification has a defined procedure for graceful disconnect entailing re-doing the entire boot process for the device when re-joining the bus. This implies re-enumeration resulting in assignment of a new logical address. The process may take up to 30 ms.

### BRIEF DESCRIPTION OF THE DRAWINGS

Particular embodiments in accordance with the invention will now be described, by way of example only, and with reference to the accompanying drawings:

FIG. 1 is a block diagram of an exemplary system with various modules interconnected with a communication bus;

FIG. 2 is a more detailed block diagram of a device for use in the system of FIG. 1, illustrating a value map that can be accessed via the communication bus of FIG. 1;

FIG. 3 is a ladder diagram of exemplary message exchanges between devices interconnected via the communication bus of FIG. 1;

FIG. 4 is a flow diagram illustrating control of sleep mode in the system of FIG. 1;

FIG. 5 is a state diagram for receiver port sleep mode;

FIG. 6 is a state diagram for transmit port sleep mode;

FIG. 7 is a more detailed ladder diagram illustrating sleep sequence;

FIG. 8 is a more detailed ladder diagram illustrating the wake up sequence; and

FIG. 9 is a block diagram of an exemplary cell phone that includes a multi-module system interconnected with a communication bus.

### DETAILED DESCRIPTION OF EMBODIMENTS OF THE INVENTION

In order to utilize the benefits of placing communication modules to sleep during active call processing in a cellular phone, for example, a method is described herein in which modules may be permitted to rapidly transition into sleep mode and then be rapidly awakened using transactions defined by the SLIMbus. Entering and exiting the sleep mode is made somewhat difficult for SLIMbus based modules due to some of its inherent properties. A procedure that is defined within the SLIMbus standard requires a complete attach/detach from the bus, which is a relatively long process that requires enumeration when the module comes out of sleep mode. In the method described herein, the logical address is maintained and there is no need for re-joining the bus, therefore the time required to enter and leave sleep mode is minimal.

A simple extension to the standard SLIMBus protocol enables graceful and rapid transition in and out of sleep mode, while avoiding the need for additional signaling or bus driver changes. No additional signaling or changes to the standard SLIMbus PHY (physical) layer are required. Existing standard transaction messages (REQUEST/REPLY) are used with the addition of a new “user” defined value-element within each SLIMbus device. This provides a method for controlling sleep mode that provides support for a framer device that sources the clock signal while in sleep mode, provides support for point-to-point and point-to-multipoint cases, and supports transition into and out-of sleep while other bus components remain active. The logical address assigned to the device is maintained, thus no re-enumeration is required which allows a short suspend/resume process. Clock Pause can be employed when all components on a bus are in sleep mode.

### SLIMbus Physical Description

In order to better understand embodiments of the current invention, aspects of the SLIMbus will be described herein. As mentioned earlier, the SLIMbus is described in more detail in various articles, such as “An Introduction to the Mobile Industry Processor Interface (MIPI) Alliance Standard Serial Low-power Inter-chip Media Bus (SLIMbus),” Kenneth Boyce, 2009, and is incorporated by reference herein. Access to the standard itself is currently limited to MIPI Alliance members. While embodiments of the invention are described herein as extensions to SLIMbus, it should also be understood that other systems in which multiple devices are interconnected via a common communication bus of some sort may also embody the present invention for controlling sleep mode.

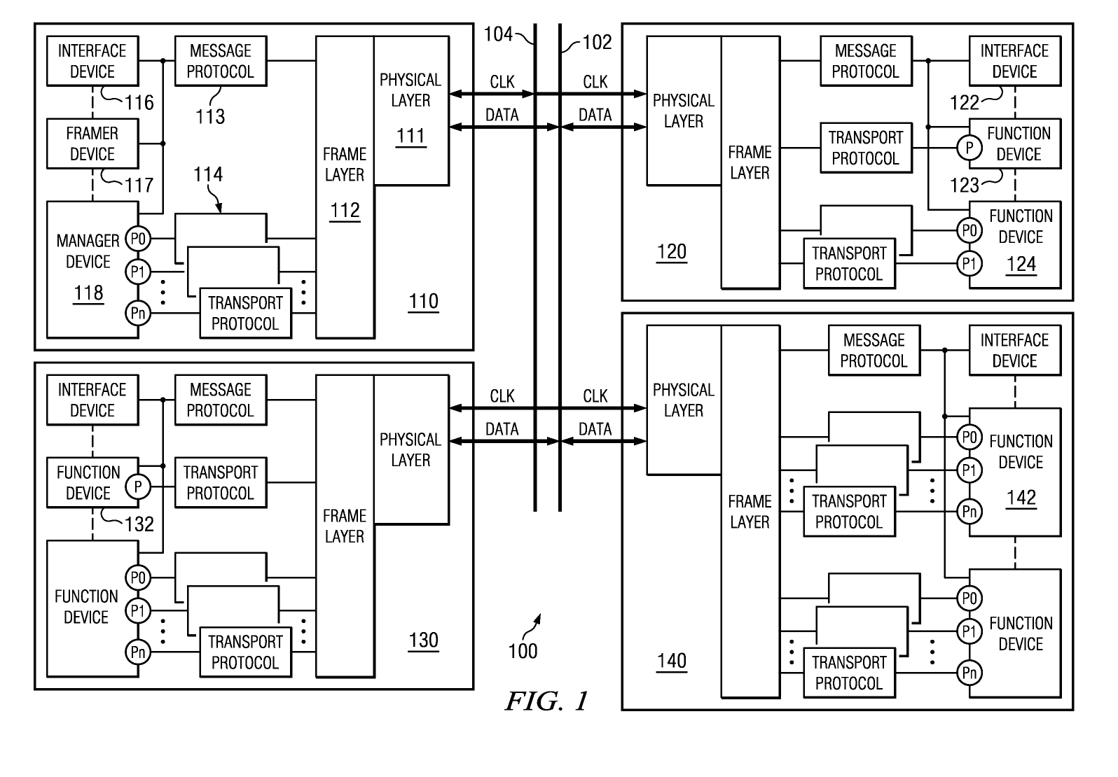

FIG. 1 is a block diagram of an exemplary system100 with various modules interconnected with a communication bus. Physically, SLIMbus consists of two terminals, the data line (DATA) 102 and the clock line (CLK) 104 which are used to interconnect multiple SLIMbus components, such as component 110, 120, 130, and 140. SLIMbus uses a multidrop bus topology where all bus signals are common to all components on the bus. As such, all components on the bus must use the same protocol for communication. This architecture was chosen as it significantly reduces bus interconnect wiring in any product using it, while at the same time allowing a multiplicity of devices and device types to be connected to the bus. A multidrop connection requires that only one transmitter device communicate at any given time on the bus to one or more receivers. SLIMbus components contend for the bus access through an arbitration procedure. SLIMbus uses a Time Division Multiplexed (TDM) architecture which allows multiple receiver and transmitter components to reside on the bus and allows all devices to inter-communicate within allocated channels and time frames. SLIMbus supports both device to device communication as well as single device to multiple device broadcast communication.

### SLIMbus Devices and Device Classes

A SLIMbus Device is a logical implementation of a system function. Devices in a Device Class category share certain characteristics and functions. SLIMbus Devices fall into Device Class definitions which specifies the minimum requirements for Device control information, Device behavior, data Transport Protocol support, and data storage necessary to implement a Device of that Device Class. Requirements for all Device Classes are shown in Table 1.

TABLE 1
Device Class requirements

| | |
|---|---|
| Device Class code | identifying the type of Device |
| Version number of | |
| the Device Class | |
| Transport support | Such as the number of Ports and required |
| requirements | attributes, directionality, and Transport |
| | Protocols, etc., that are supported by these |
| | Ports |
| Message support | Identifying which Messages in addition to |
| requirements | Core Messages are supported by the Device. |
| Information | Identifying the Core Information Elements |
| support | and associated codes that are supported by |
| | the Device. |
| Operation | Identifying all other behavior that is |
| requirements | important to the operation of a Device that |
| | belongs to that Device Class. |

There are four SLIMbus Device Classes defined at the release of Version 1.0 of the SLIMbus specification: Manager, Framer, Interface, and Generic. These Device Classes permit complete SLIMbus systems to be designed and implemented without any additional Device Classes. However, the set of Device Classes is expandable if desired. When additional Device Classes are defined, those Device Class codes will be allocated by the MIPI Alliance.

Referring still to FIG. 1, a Manager Device, such as manager device 118, is responsible for booting SLIMbus, and performs bus administration (enumeration of Components and Devices, bus configuration, and dynamic channel allocation). In a typical SLIMbus system the Manager would be located in a baseband or application processor rather than in a peripheral component. If a system contains two Managers, only one is allowed to be active at any given time.

A Framer Device, such as framer device 117, delivers a clock signal on the CLK line to all SLIMbus Components, and also contains logic to transmit the Guide and Framing Channels (Framing Information) on the DATA line in order to establish the highest level TDM Frame Structure of the bus and communicate that information to other SLIMbus Devices for establishing synchronization. The clock may be a high quality clock useful for audio decoding and DACs, which may eliminate the need for additional clock generation within the system.

In each Component, the Interface Device, such as interface device 116, provides bus management services, controls the Frame Layer 112, monitors Message Protocols 113 implemented by the Component, reports information about the status of the Component, and manages the Component reset so that a Component can properly sequence its Devices.

A Generic Device, or Generic Function, is a Device other than a Manager, Framer, or Interface. A Generic Device, such as function device 122, is generally considered to be the device to provide certain application functionality such as, for example, conversion from digital audio to analog (DAC) and vice versa (ADC). The Generic Device Class is used if no other specific device class for the application functionality exists. As an example, if a Microphone Device Class existed you would not ordinarily use a Generic Device class definition for microphone functionality.

Implementation of a Functional Device also requires the use of an Interface Device, and the associated Enumeration and Logical Addresses (EA and LA), Information and Value Elements (IE and VE), and Ports (P) of each device, which are used to establish bus connections, control and status information flow, and digital audio (or other data) flow. Device Information and Value Elements Information Elements (IE) and Value Elements (VE) are data storage elements used to hold status, configuration or other important information needed by a Device. The data stored may be Boolean in nature, or may have many values, depending upon the type of Device. These IE and VE elements effectively replace registers typically found behind conventional control interfaces such as I2C or SPI.

An Information Element is a specific piece of data that resides in a Device, and is available to other Devices via Messages. Categories of Information Elements are: core, device class specific, user information. Core Information Elements are the same for all Devices of all Device Classes. Device Class-specific Information Elements are the same for all Devices of a particular Device Class, but may be different for all Devices of a different Device Class. User-Information Elements are specific to a particular product or product family.

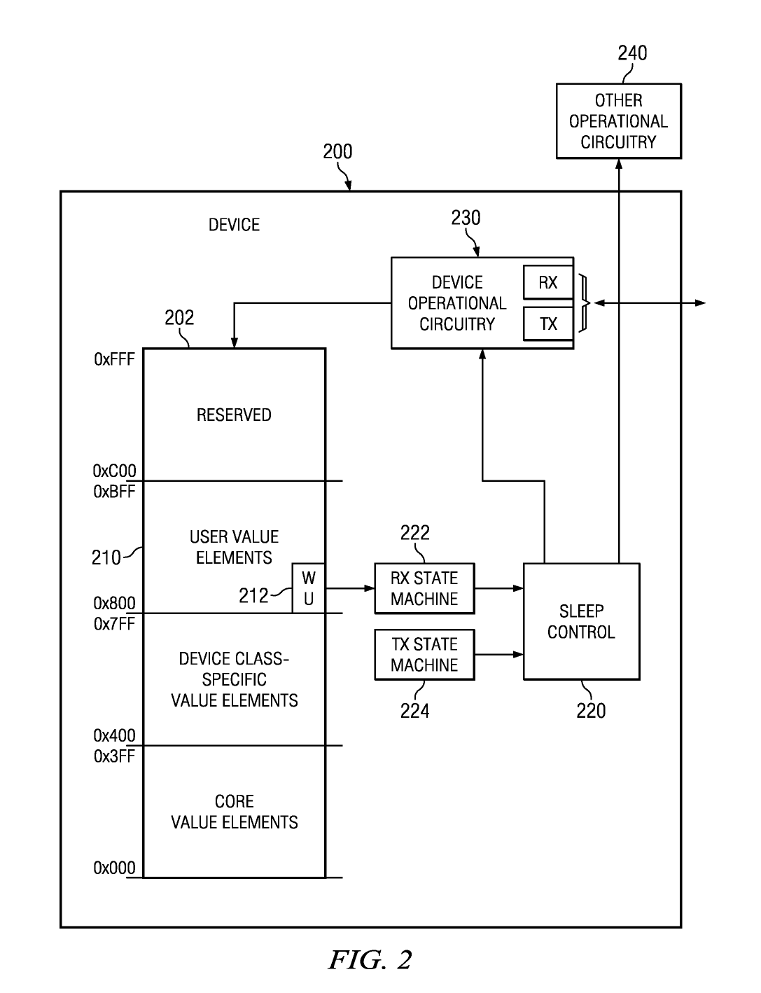

FIG. 2 is a more detailed block diagram of a device 200 that includes map 202 of value elements that can be accessed via the SLIMbus bus of FIG. 1. Information elements are arranged in a similar map. A Value Element provides a standardized method to read and update Device parameters. Unlike an Information Element, a Value Element can be set to a specific value using a specific Message for the purpose. Value Elements are typically parameters that are used to configure Device behavior. The Value Elements are organized into a Value Map 200 that has three one kilobyte regions, as shown in FIG. 2. Byte Addresses in the range 0xC00 to 0xFFF are reserved.

Value Elements are be located in the appropriate region of the Value Map. Each Value Element occupies no more than sixteen bytes of the Value Map address space. There is no requirement for a Device to use the entire Byte Address range. In addition, there is no required mapping between a Device's Byte Addresses and any internal memory map within a Component. The use of value elements in embodiments of the current invention will be described in more detail below.

### Device Addressing

SLIMbus uses a 48-bit Enumeration Addresses (EA) to uniquely identify Devices which can announce their presence on the bus. Each Device has an EA, which incorporates Manufacturer ID, Product Code, Device Index, and Instance Value for a Device. The Manufacturer ID code is supplied by the MIPI Alliance and uniquely identifies the manufacturer of the Device, similar to the manufacturer IDs used with PCI bus components. The Device Index code uniquely identifies multiple Devices within a single Component. The Instance Value code is for the case where multiple Devices of the same type or Class are attached to the bus.

After enumeration, the Active Manager assigns an 8-bit Logical Address to Device (LA) which speeds up communication with devices, and is typically used until the bus is powered down. On the next bus power up, or if the Device drops off the bus and re-connects, it is entirely possible that a new Logical Address is assigned.

### SLIMbus Component

Referring again to FIG. 1, a SLIMbus Component contains two or more SLIMbus Devices. A SLIMbus Component must have one (and only one) SLIMbus Interface Device, and may have one or more other types of SLIMbus devices. For example, SLIMbus component 110 contains interface device 116, framer device 117 and manager device 118, while component 120 contains interface device 122, function device 123, and function device 124. As shown in FIG. 1, Data and Control information sent from a Device are first encoded using the Message Protocol, such as message layer 113, for control information and the Transport Protocol, such as transport layer 114, for data. The data and control streams are interleaved by the Frame Layer 112, such as frame layer 112 and converted by the Physical Layer, such as physical layer 111, into electrical signals on the DATA and CLK lines.

In the opposite direction, the signals on the CLK and DATA lines are translated by the Physical Layer into a bit stream, which is then split into Data and Control streams by the Frame Layer, which, in turn, are decoded by the corresponding protocols and sent to the appropriate Devices within the Component.

### SLIMbus DATA and CLK

The DATA and CLK lines are typically attached to two or more SLIMbus Devices contained in one or more SLIMbus Components to form a SLIMbus system. All SLIMbus Devices use DATA and CLK to synchronize with the bus configuration in use, to receive or transmit messages and data, and to implement bus arbitration, collision detection, and contention resolution between devices.

For all SLIMbus Components, except one containing a Framer Device, the CLK terminal is input only. If a SLIMbus Component is the Framer Device, or contains a Framer Device, the CLK signal is bidirectional. This is because the Framer Device is the only SLIMbus device allowed to control the CLK line. The CLK line has only two states; driven high or driven low. The Component that contains the active Framer is called the Clock Source Component.

For all SLIMbus Components, the DATA line is bidirectional, and carries all information sent or received on the bus using Non-Return-to-Zero Inverted, or NRZI encoding. The DATA line is driven on the positive edge and read on the negative edge of the CLK line. The DATA line can be driven high, driven low, or held at the high or low level, depending upon the particular operational mode of a SLIMbus Device.

The SLIMbus interface DATA and CLK lines use CMOS-like single-ended, ground referenced, rail-to-rail, voltage mode signals, and signaling voltages are specified with respect to the interface supply voltage. In the SLIMbus specification, interface supply voltages +1.8Vdd or +1.2Vdd are recommended even though other parts of a SLIMbus device may use different supply voltages.

### Information Requests and Value Requests

The SLIMbus defines a Message Protocol used by Devices to exchange Messages. The Message Protocol consists of the Message Channel, which carries Messages between Devices, the Guide Byte, which contains the necessary information for Components to synchronize with the Message Channel, the Guide Channel, which carries the Guide Byte, and a set of behaviors that describe the flow of Messages between Devices. A Message is an integer number of bytes in length, ranging from a minimum of six to a maximum of thirty-nine bytes. Fields are provided for channel arbitration, source and destination addresses, Message contents (payload), Message integrity and acknowledgement. The Guide Byte contains fields so that a Device can determine the location of Messages within the Message Channel, and the integrity of the Guide Byte. Since two Slots are required to carry a byte, the Message Channel and the Guide Channel are organized as streams of Slot-pairs. These channels always occupy an even number of Slots in a Frame. Both Slots of a Message Channel Slot-pair are always contained within a single Frame, though they can be in different Subframes. When a Message is put into the Message Channel, the Message is byte justified to a Slot-pair, i.e. the first Cell of the Slot-pair holds the first bit of the Message. The Guide Channel occupies a predetermined set of Slots within a Superframe. These Slots are located so that the Guide Channel Slot-pair never falls between the Slots of a Message Channel Slot-pair.

The SLIMbus defines four types of REQUEST messages: REQUEST_INFORMATION, REQUEST_CLEAR_INFORMATION, REQUEST_VALUE or REQUEST_CHANGE_VALUE. These four Messages are called REQUEST Messages, while the REPLY_VALUE and REPLY_INFORMATION Messages are called REPLY Messages. A Value REQUEST Message may be handled with an abbreviated REPLY Message in which the Message Payload contains only a Transaction ID. The CHANGE_VALUE Message instructs a Device to update the indicated Value Slice.

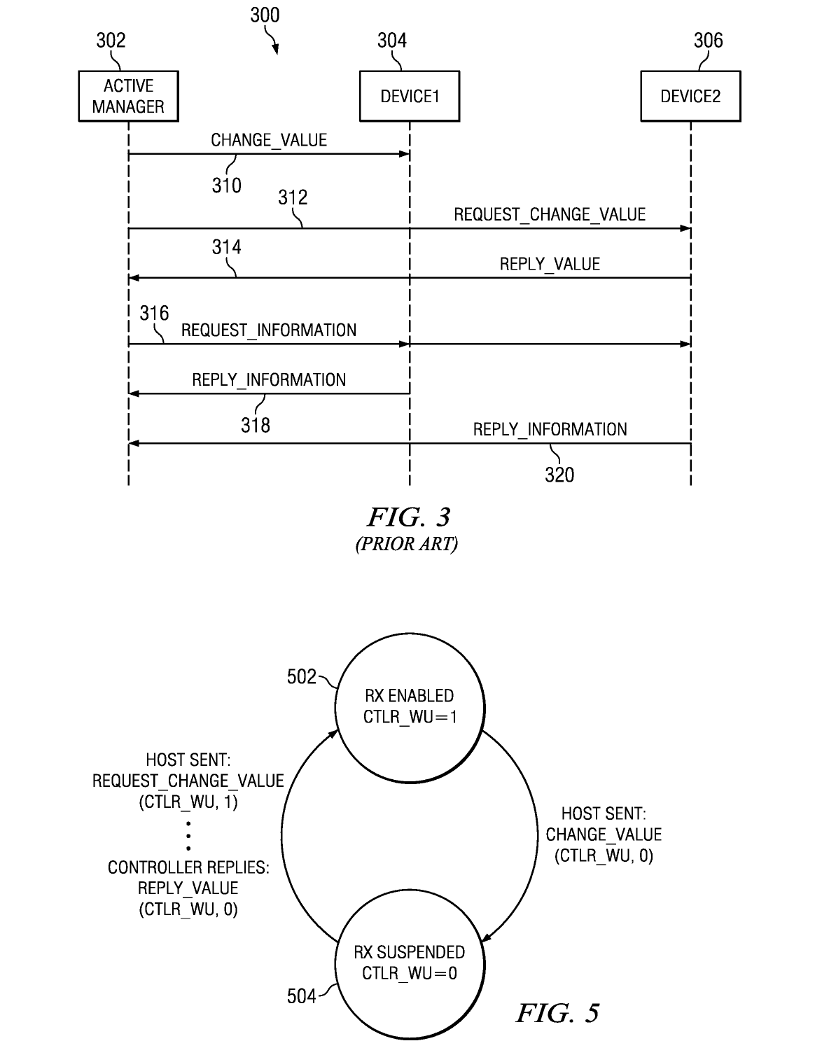

FIG. 3 is a ladder diagram of exemplary prior art message exchanges between devices interconnected via the SLIMbus bus of FIG. 1. This example includes a CHANGE_VALUE message 310 between a source device 302 and target device 304. Also illustrated is an atomic REQUEST_CHANGE_VALUE message 312 between device 302 and device 306, in which device 306 responds with a REPLY_VALUE message 314. Also illustrated is a REQUEST_INFORMATION message 316 that is directed to multiple devices 304 and 306, which result in a REPLY message 318 from device 304 and a REPLY message 320 from device 306.

The source Device of each REQUEST Message shall generate a Transaction ID (TID) for the Message and then wait for the corresponding REPLY Message with the same Transaction ID. Normally, the initiator receives a corresponding REPLY Message. However, in some cases a REPLY Message might not arrive. Therefore, the initiator may expire pending transactions if the request remains pending. This implies that the Transaction ID can be used again and a REPLY Message is not expected anymore by the initiator. For these Messages, the source Device may choose to resend the REQUEST. If a REPLY Message is received without a corresponding pending Transaction ID, the Message should be discarded by the receiving Device.

A destination Device of a REQUEST Message should send a corresponding REPLY Message. The REPLY Message contains the same Transaction ID as the REQUEST Message, and has the Logical Address of the source of the REQUEST Message as its Destination Address.

The REQUEST_CLEAR_INFORMATION and the REQUEST_CHANGE_VALUE Messages request the Target to behave as though it performs three distinct actions: saves the current contents of the indicated Information or Value Slice, clears or updates the indicated Information or Value Slice and replies to the REQUEST Message with the saved contents. In addition, the Target behaves as though the first two actions are a single, atomic operation. In other words, the contents of the indicated Information Slice or Value Slice shall not change between saving the contents and clearing or updating the contents.

### SlimBUS Sleep Protocol Implementation Description

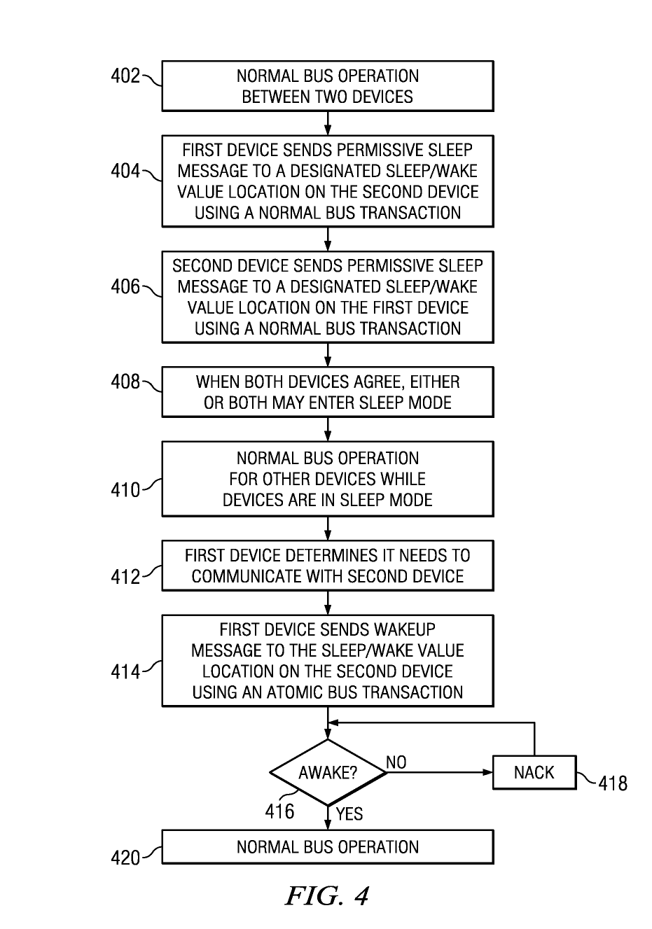

FIG. 4 is a flow diagram illustrating a rapid sleep protocol for use on the SLIMbus, which will now be described in more detail. Referring again to FIG. 2, the SLIMbus sleep protocol (SB_SP) is embodied using two independent state machines 222. 224, one for the receiver port (RX) and one for transmission port (TX) which are symmetrically run on both devices that are in communication, as indicated at 402.

Each device is responsible for suspending its own Tx port, which is the remote device's Rx port, when it doesn't have any data to transmit to the remote, as indicated at 404, 406. This is done by sending a SLIMbus (SB) standard CHANGE_VALUE command to deassert the corresponding sleep/wakeup (WU) value-element 212 of the remote device. WU value element 212 is located within the user value element portion 210 of the device's value map. Each device is allowed and may go to sleep once its Rx port has been suspended by a remote device and normally following its own Tx port suspend completion, as indicated at 408. This also allows the remote device to enter sleep mode.

Once the two devices agree to they may enter sleep mode, other devices on the bus may continue to communicate, as indicated at 410. The Active Manager may also optionally pause the bus clock using the SB standard's defined clock pause sequence, using the NEXT_CLOCK_PAUSE command, following the suspension of all the bus' channels when all device's Tx/Rx ports are in suspend state. If the clock is stopped, then the Active Manager must restart the clock when a device needs to wake up before further message traffic can be handled. This is done using the SB standard's defined clock resume sequence.

Referring again to FIG. 2, sleep control function 220 monitors both state machines 222, 224 and is coupled to operational circuitry 230 on the device and/or to operational circuitry 240 located in another device within the component. When both state machines enter the suspend state, then sleep control function 220 allows the coupled operational circuitry to enter a low power sleep mode. For example, a supply voltage (VDD) may be removed, a clock signal may be halted or the frequency may be reduced, etc. A small portion of the physical layer hardware on the devices that are in sleep mode is maintained in an active state so that the device may monitor bus messages and look for a wakeup message.

Correspondingly, each device is responsible for resuming its own Tx port (remote device's Rx port) when it requires data transfer to the remote device, as indicated at 412. This is done by sending a SB standard REQUEST_CHANGE_VALUE command, asserting the corresponding wakeup WU value-element of the remote device, as indicated at 414. Until the remote device is fully awake 416, it may send a NACK 418 status in response to the REQUEST_CHANGE_VALUE command. Once it is fully awake, it sends a REPLY command to complete the REQUEST_CHANGE_VALUE command and normal bus operation resumes between the two devices, as indicated at 420. The wakeup sequence may be initiated by either device.

FIG. 5 is a state diagram for receiver port sleep mode. For sake of terminology in this example, assume a host device is in communication with a controller device. The host device may be in component 110 of FIG. 1, for example, while the controller device may be in component 120, for example. The following description is from the controller device's viewpoint; however it also applies to the host device as the protocol is symmetrical.

The RX state machine is totally controlled by the Host, and except for acknowledging the host upon a reception of CTLR_WAKEUP request, the controller stays passive. During normal communication, the RX state machine is in RX enabled state 502. When a CHANGE_VALUE command that changes the controller wakeup value (CTRL_WU) to “0”, the state machine transitions to the RX suspended state 504. It remains in this state until a REQUEST_CHANGE_VALUE command is received that sets the CTRL_WU value to “1”. The controller then acknowledges this command with a REPLY command and transitions to the RX enabled state 502.

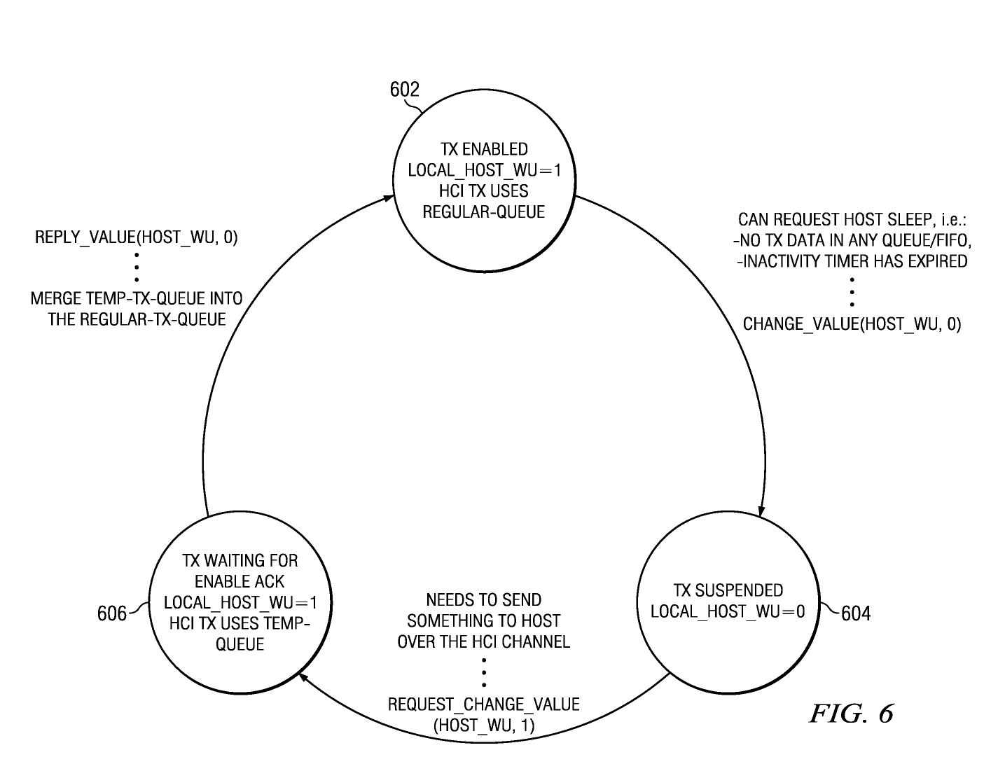

FIG. 6 is a state diagram for transmit port sleep mode. The TX state machine is managed by the controller. During normal communication, the TX state machine is in the TX enabled state 602. The host wakeup (HOST_WU) value is “1”. When the conditions are right to allow the host to go to sleep, i.e. all the TX queues and FIFOs (either firmware (FW) or hardware (HW)) are empty, the Inactivity-Timer has expired, etc., the controller issues CHANGE_VALUE(HOST_WU, 0) and the local TX state is moved to TX_SUSPENDED 604.

Then, when there is a need to send the host something over the SB, the controller issues REQUEST_CHANGE_VALUE(HOST_WU,1) and transitions to state TX_WAIT_FOR_WAKEUP_ACK 606. All packets to send to the host are buffered in a temporary queue, while waiting for the host to acknowledge the wakeup request. Finally, when the host responds with REPLY_VALUE(HOST_WU, 0) the tx state is changed to TX_ENABLED 602, and all buffered TX packets are moved to the “regular” TX queue and transmitted to the host.

SLIMbus messages may be addressed to a device even while it is asleep. When the SB physical layer of the component detects a message that is destined to one of the SB devices of the component, it will assert a wakeup signal that will cause the SB_SP handler to wake up. In the meantime, the SB message (and perhaps retransmissions of it) may be NACKd, if the respective FIFO is not yet operational. Once the needed voltages and clocks are available, the retransmitted message enters the FIFO and the appropriate interrupt request is set into the message handler logic. Once the message handler logic is fully awake, the message will be processed.

The sequence described above does not cause the TX and/or RX state to exit from the Suspended state, unless the message being received is actually REQUEST_CHANGE_VALUE(CTLR_WU, 1). Once the needed message-processing is done, the controller may go back to sleep, providing all the needed conditions are met.

Message transactions are also defined for situation where certain SB Message is expected to be received in the “very near future”. Sending a REQUEST_VALUE, REQUEST_CHANGE_VALUE, REQUEST_INFORMATION and REQUEST_CLEAR_INFORMATION start a transaction, which is ended upon reception of the respective REPLY message, or upon timeout. Receiving BEGIN_RECONFIGURATION starts a transaction, which is ended upon reception of RECONFIGURE_NOW.

A queue is defined for outgoing SB Messages (SB_MSG_TX_QUEUE). A message is deleted from the queue only after it is successfully sent to its destination (i.e. PACKd). A message is retransmitted, unless PACKd, by writing it again into the SB queue FIFO and triggering its transmission.

### Entering Sleep

The controller is allowed to go to sleep (stop the clocks, etc.), only when all of the following conditions are met: both TX and RX are in the Suspended state; and SB_MSG_TX_QUEUE is empty, which means that no SLIMbus message is pending transmission.

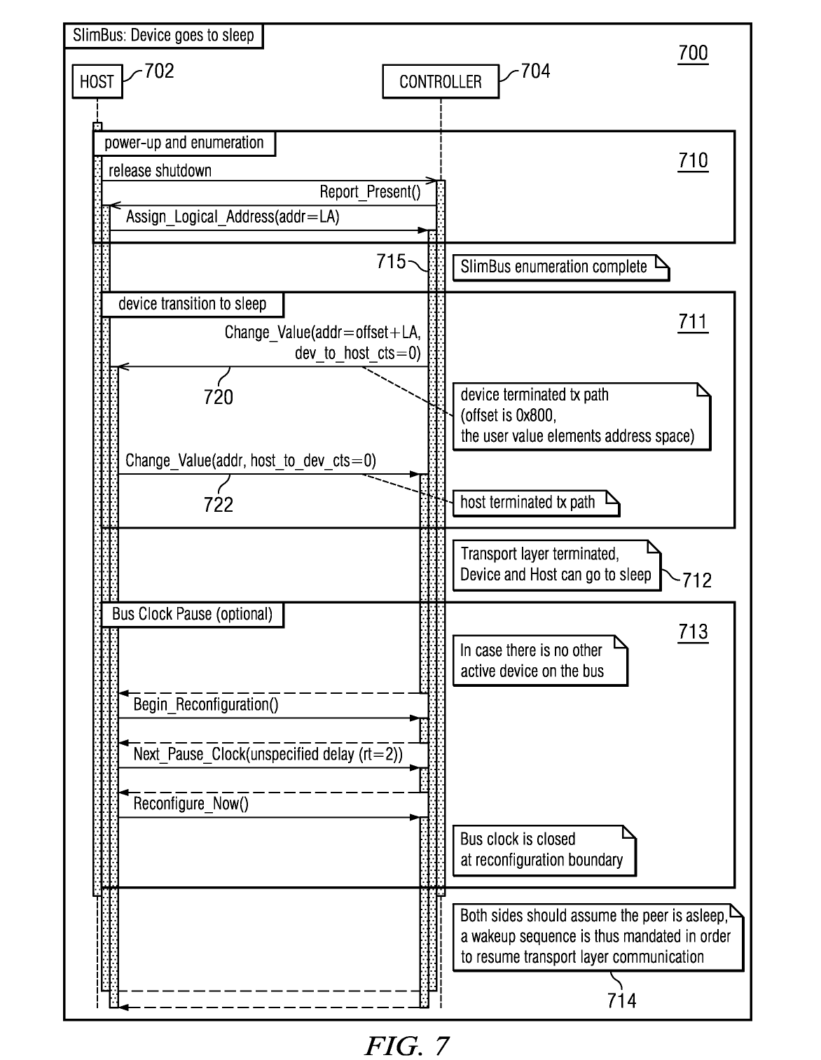

FIG. 7 is a more detailed ladder diagram 700 illustrating the sleep sequence. Using the same terminology as for FIGS. 5 and 6, host device 702 is communicating with controller device 704 over the SLIMbus. Initially, an enumeration process 710 is performed that provides a logical address to each device on the bus.

At some later period 711, controller 704 determines that it has nothing to transmit to the host and sends 720 a CHANGE_VALUE command that changes the host sleep/wakeup value (HOST_WU) to “0”. The host RX state machine then enters the suspended state, as described with respect to FIG. 5. The host also determines that it has nothing to transmit to the controller, and it sends 722 a CHANGE_VALUE command that changes the controller sleep/wakeup value (CTRL_WU) to “0”. At this point, the transport layer is idled and both host device 702 and controller device 704 may enter sleep mode; however, they are not forced to enter sleep mode. One or the other device may remain active for other functional reasons.

Note that either the host or the controller may issue the first CHANGE_VALUE command. Once they have both issued the CHANGE_VALUE command, then both may immediately transition to sleep mode.

On the other hand, when the controller, for example, has nothing to send to the host, it can therefore suspend its own Tx port (Hosts Rx port), allowing the host to go to sleep if it wishes to do so. However, if the host still wishes to communicate with the controller, then host would not actually go to sleep and it would therefore not suspend its own Tx port, which is the controller's corresponding Rx port. This is perfectly valid since the Host's Tx port has not been suspended yet and therefore it is not allowing the controller to go to sleep. The result of this scenario is that both the host and the controller would remain active, with the exception that the host is allowed and may go to sleep for short periods, for example between communication bursts to the controller.

Note that if the host's communication to the controller would require a communication response from the controller to the host, which is normally the case, e.g. acknowledgements or other feedback, the controller would have to resume its Tx port first in order to resolve a potential “race” condition where the host has completed its communication and wants to go to sleep before the time the controller starts to communicate back.

As mentioned earlier, if all devices are in sleep mode, the active manager may issue a clock pause command, as illustrated at 713, using the SB defined protocol.

Regardless of whether the clock was stopped, both devices are now assumed to be asleep, and a wakeup sequence is required to resume transport communication, as indicated at 714. However, as discussed above, a device may choose to not go to sleep, even when it has permission to go to sleep. Advantageously, the logical addresses are maintained in the physical layer hardware of each device, as indicated at 715. This allows each device to awaken rapidly without repeating the normal SB enumeration process.

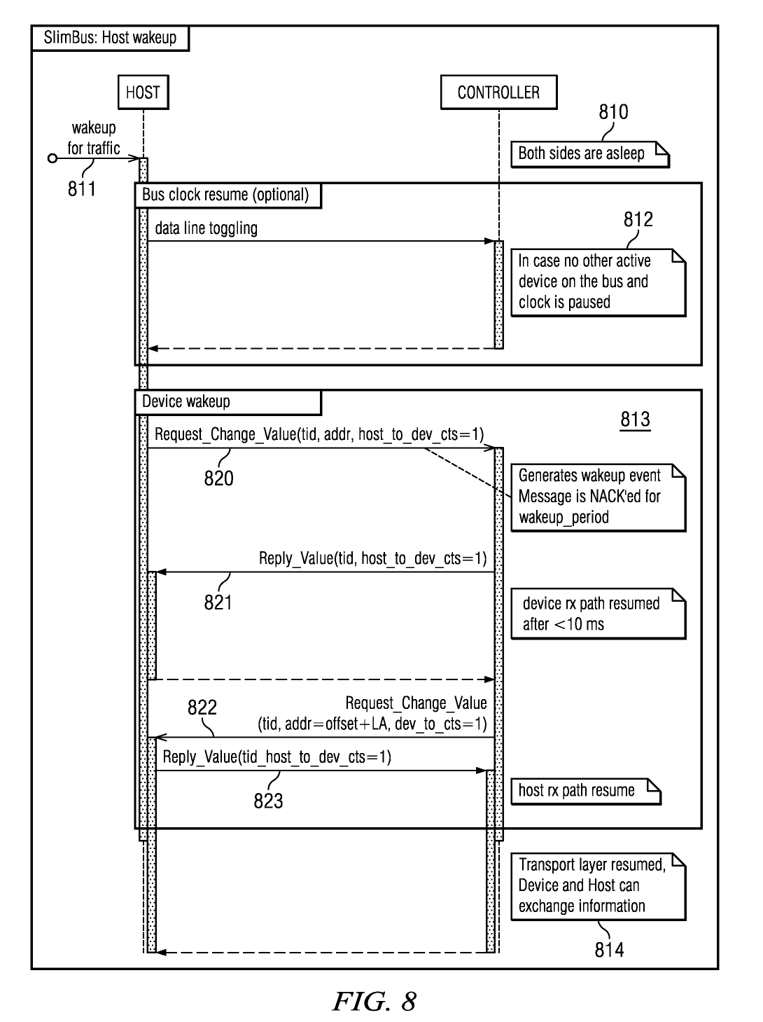

FIG. 8 is a more detailed ladder diagram illustrating the wake up sequence. Both the host and controller are assumed to be asleep, as indicated at 810. Incoming traffic 811 initiates a wake up sequence. If the clock was off, then a normal SB clock restore process is performed, as indicated at 812. Otherwise, the clock was on and normal bus communications traffic was flowing.

In this example, the host initiates the wakeup sequence 813 after receiving the traffic wake up signal 811. The host issues a REQUEST_CHANGE_VALUE(CTLR_WU,1) as indicated at 820 and transitions to a TX_WAIT_FOR_WAKEUP_ACK state, as described with respect to FIG. 6. The device then replies with a REPLY_VALUE(CTLR_WU, 0) 821 and the host tx state is changed to TX_ENABLED, and all buffered TX packets are moved to the “regular” TX queue and the device RX path is resumed.

In response to receiving the wakeup from the hose, the controller also issues REQUEST_CHANGE_VALUE(HOST_WU,1) 822 and transitions to the TX_WAIT_FOR_WAKEUP_ACK state. When the host responds with REPLY_VALUE(HOST_WU, 0) 8232 the controller tx state is changed to TX_ENABLED and the host RX path is resumed.

With host and device RX paths resumed, the transport layer is resumed and the host and device can exchange data, as indicated at 814. The entire resume process takes less than 10 ms, which is significantly faster than the SB re-join and re-enumeration protocol.

### Multiple Device Sleep Protocol

Referring again to FIG. 1, devices may have transport channels established with more than one other device. For example, device 123 of component 120 may have a transport channel established with device 132 of component 130 and also with device 142 of component 140. In this case, device 123 will have to manage the sleep protocol with both device 132 and device 142. It may do this by maintaining additional RX and/or TX state machines for each transport channel. In this example, device 123 would need to receive a sleep message that suspends the TX port of both device 132 and device 142, corresponding to device 123's Rx ports, before device 123 is allowed to go to sleep. Similarly, device 123 may maintain two TX state machines and send sleep message to both devices, suspending its own Tx ports to their corresponding Rx ports, for allowing them also to go to sleep. In general, each device needs to make sure that all of its active channels with all corresponding devices have been suspended, and specifically all of its Rx ports that are connected to all corresponding device's Tx ports, before it's allowed and can actually go to sleep.

### System Example

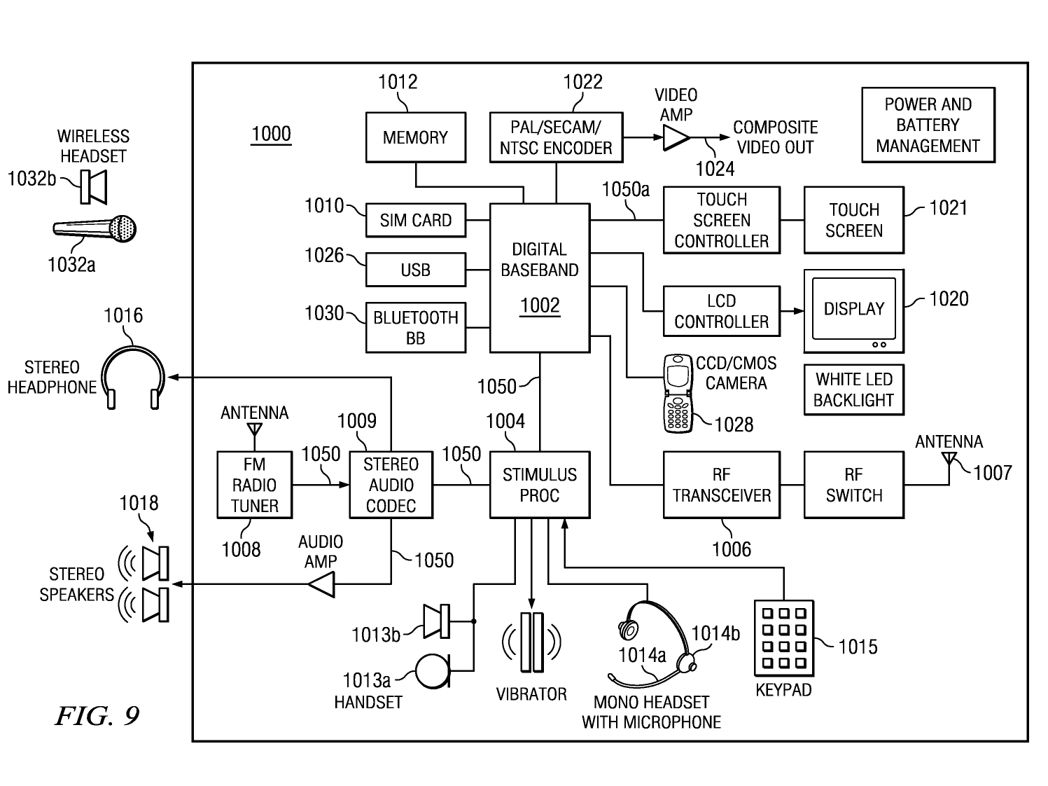

FIG. 9 is a block diagram of mobile cellular phone 1000. Digital baseband (DBB) unit 1002 may include a digital processing processor system (DSP) that includes embedded memory and security features. Stimulus Processing (SP) unit 1004 receives a voice data stream from handset microphone 1013a and sends a voice data stream to handset mono speaker 1013b. SP unit 1004 also receives a voice data stream from microphone 1014a and sends a voice data stream to mono headset 1014b. Usually, SP and DBB are separate ICs. In most embodiments, SP does not embed a programmable processor core, but performs processing based on configuration of audio paths, filters, gains, etc being setup by software running on the DBB. In an alternate embodiment, SP processing is performed on the same processor that performs DBB processing. In another embodiment, a separate DSP or other type of processor performs SP processing.

RF transceiver 1006 is a digital radio processor and includes a receiver for receiving a stream of coded data frames from a cellular base station via antenna 1007 and a transmitter for transmitting a stream of coded data frames to the cellular base station via antenna 1007. RF transceiver 1006 is coupled to DBB 1002 which provides processing of the frames of encoded data being received and transmitted by cell phone 1000.

DBB unit 1002 may send or receive data to various devices connected to universal serial bus (USB) port 1026. DBB 1002 can be connected to subscriber identity module (SIM) card 1010 and stores and retrieves information used for making calls via the cellular system. DBB 1002 can also connected to memory 1012 that augments the onboard memory and is used for various processing needs. DBB 1002 can be connected to Bluetooth baseband unit 1030 for wireless connection to a microphone 1032a and headset 1032b for sending and receiving voice data. DBB 1002 can also be connected to display 1020 and can send information to it for interaction with a user of the mobile UE 1000 during a call process. Display 1020 may also display pictures received from the network, from a local camera 1028, or from other sources such as USB 1026. DBB 1002 may also send a video stream to display 1020 that is received from various sources such as the cellular network via RF transceiver 1006 or camera 1028. DBB 1002 may also send a video stream to an external video display unit via encoder 1022 over composite output terminal 1024. Encoder unit 1022 can provide encoding according to PAL/SECAM/NTSC video standards. In some embodiments, audio codec 1009 receives an audio stream from FM Radio tuner 1008 and sends an audio stream to stereo headset 1016 and/or stereo speakers 1018. In other embodiments, there may be other sources of an audio stream, such a compact disc (CD) player, a solid state memory module, etc.

SLIMbus 1050 couples tuner 1008, codec 1009 and stimulus processor 1004 to DBB 1002 and transfers audio streams between those components. The SLIMbus continues via segment 1050a to couple to touch screen 1021 for haptic feedback. The various devices within these components may sense when they have no traffic to transmit and initiate sleep initiation sequences as described above. Similarly, when traffic is detected, then the source component may initiate a wakeup sequence to re-establish transmission in a rapid manner, as described above.

### Other Embodiments

While the invention has been described with reference to illustrative embodiments of a SLIMbus based system, this description is not intended to be construed in a limiting sense. Various other embodiments of the invention will be apparent to persons skilled in the art upon reference to this description. For example, other types of communication buses may be embodied with a sleep protocol as described herein for rapid transition from a sleep state to a wakeup state. Many types of buses that support atomic memory mapped transactions may be configured to embody the permissive sleep protocol described herein.

While a mobile device, such as a cell phone was described in detail herein, other embodiments of the invention can be found in other types of mobile devices, such as any of a variety of devices such a laptop computer, a Personal Digital Assistant (PDA), a smart phone or other electronic devices. Other embodiments may be less mobile devices such as desktop computers, servers, and other systems that may benefit from a simple interconnect scheme with a sleep protocol to support rapid wakeup to allow system power savings.

A system with multiple components that are coupled with a communication bus that supports a sleep protocol as described herein may be embodied by multiple components that are placed on a single substrate and interconnected via signal traces on the substrate, such as a system on a chip (SOC) integrated circuit.

Another embodiment may have components that are packaged in separate packages and connected via a communication bus that is embodied as discrete wires, a flexible cable assembly, signal lines on a circuit board, or other types of physical interconnect structures.

The techniques described in this disclosure may be implemented in hardware, software, firmware, or any combination thereof. If implemented in software, the software may be executed in one or more processors, such as a microprocessor, application specific integrated circuit (ASIC), field programmable gate array (FPGA), or digital signal processor (DSP). The software that executes the techniques may be initially stored in a computer-readable medium such as compact disc (CD), a diskette, a tape, a file, memory, or any other computer readable storage device and loaded and executed in the processor. In some cases, the software may also be sold in a computer program product, which includes the computer-readable medium and packaging materials for the computer-readable medium. In some cases, the software instructions may be distributed via removable computer readable media (e.g., floppy disk, optical disk, flash memory, USB key), via a transmission path from computer readable media on another digital system, etc.

Certain terms are used throughout the description and the claims to refer to particular system components. As one skilled in the art will appreciate, components in digital systems may be referred to by different names and/or may be combined in ways not shown herein without departing from the described functionality. This document does not intend to distinguish between components that differ in name but not function. In the discussion and in the claims, the terms “including” and “comprising” are used in an open-ended fashion, and thus should be interpreted to mean “including, but not limited to . . . .” Also, the term “couple” and derivatives thereof are intended to mean an indirect, direct, optical, and/or wireless electrical connection. Thus, if a first device couples to a second device, that connection may be through a direct electrical connection, through an indirect electrical connection via other devices and connections, through an optical electrical connection, and/or through a wireless electrical connection.

Although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both”. The term “and/or” is used in the same manner, meaning “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

It is therefore contemplated that the appended claims will cover any such modifications of the embodiments as fall within the true scope and spirit of the invention.

What is claimed is:

1. A method for controlling sleep mode in a device having a receive port and a transmit port, the method comprising:
establishing one location of a plurality of locations in a first device accessible via a communication bus as a sleep/wake control location;
receiving a command to store a sleep value in the sleep/wake control location using a transaction on the communication bus to indicate no pending traffic for the receive port;
determining that there is no pending traffic on the transmit port; and
placing the first device in a sleep mode.

2. The method of claim 1, further comprising:
receiving a command to store a wake value in the sleep/wake control location using an atomic transaction on the communication bus to indicate pending traffic for the receive port;
waking the first device from sleep mode; and
responding to the atomic transaction with a reply command to indicate the receive port is ready to receive the pending traffic.

3. The method of claim 2, wherein the atomic transaction is received from a second device, further comprising:
sending a command from the first device to store a wake value in a sleep/wake control location of the second device using a second atomic transaction on the communication bus to indicate pending traffic from the transmit port of the first device for the receive port of the second device; and
receiving a reply command from the second device to the second atomic transaction to indicate the receive port of the second device is ready to receive the pending traffic from the first device, thereby restoring two-way communication between the first device and the second device.

4. The method of claim 1, wherein the command to store a sleep value is received from a second device, further comprising:
sending a command from the first device to the second device to store a sleep value in a sleep/wake control location of the second device using a transaction on the communication bus to indicate no pending traffic for a receive port of the second device;
determining that there is no pending traffic on a transmit port of the second device; and
placing the second device in sleep mode.

5. The method of claim 4, further comprising establishing a transport channel between the receive port and transmit port of the first device and the receive port and transmit port of the second device prior to receiving the command to store a sleep value.

6. The method of claim 5, further comprising establishing a transport channel between the receive port and transmit port of the first device and a receive port and a transmit port of a third device, wherein the first device can be placed in the sleep mode only when it receives a command to store a sleep value in the sleep/wake control location from the second device and from the third device.

7. The method of claim 1, further comprising:
receiving a command to store a sleep value in the sleep/wake control location using a transaction on the communication bus to indicate no pending traffic for the receive port;
determining that there is pending traffic on the transmit port; and
maintaining the first device in a wake mode.

8. A method for controlling sleep mode in a plurality of devices coupled via a communication bus, each device having a receive port and a transmit port, the method comprising:
establishing one location of a plurality of locations in each of the plurality of devices accessible via a communication bus as a sleep/wake control location;
establishing a logical address assignment for each of the plurality of device;
establishing a transport channel between a pair of the devices using the logical addresses of the pair of devices, such that a transmit port of each of the pair of devices is logically coupled to a receive port of the corresponding device via the communication bus;
determining that there is no pending traffic on the transmit port of a first device of the pair of devices and therefore no pending traffic on the receive port of the second device of the pair of devices;
sending a command via the communication bus from the first device to the second device to store a sleep value in the sleep/wake control location of the second device to indicate no pending traffic for the receive port of the second device;
determining that there is no pending traffic on the transmit port of the second device and therefore no pending traffic on the receive port of the first device;
sending a command via the communication bus from the second device to the first device to store a sleep value in the sleep/wake control location of the second device to indicate no pending traffic for the receive port of the first device;
allowing the first device to enter a sleep mode while there is no pending traffic on the receive port of the first device and no pending traffic on the transmit port of the first device; and
allowing the second device to enter a sleep mode while there is no pending traffic on the receive port of the second device and no pending traffic on the transmit port of the second device.

9. The method of claim 8, further comprising maintaining the logical address of the first device and the second device while they are in sleep mode.

10. The method of claim 9, further comprising:
determining that there is new traffic in the first device ready to transmit to the second device and therefore there is pending traffic for the receive port of the second device;
sending a command from the first device to the second device to store a wake value in the sleep/wake control location of the second device using an atomic transaction on the communication bus to indicate pending traffic for the receive port of the second device;
waking the second device from sleep mode; and
responding to the atomic transaction with a reply command from the second device to the first device to indicate the receive port of the second device is ready to receive the pending traffic.

11. The method of claim 10, wherein the atomic transaction uses the logical address of the first device and the second device.

12. The method of claim 10, further comprising transmitting the new traffic from the transmit port of the first device to the receive port of the second device via the communication bus using the maintained logical address of the second device.

13. The method of claim 8, further comprising establishing a transport channel between the receive and transmit ports of the first device and a receive port and a transmit port of a third device, wherein the first device is allowed to enter the sleep mode only when it receives a command to store a sleep value in the sleep/wake control location from the second device and from the third device.

14. A system, comprising:
a plurality of devices communicatively coupled via a communication bus, wherein each of the devices comprises:
a receive port configured to receive data via the communications bus;
a transmit port configured to transmit data via the communications bus;
queue logic coupled to the transmit port, the queue logic operable to hold data pending transmission;
transmit logic configured to determine when data is pending for the transmit port;
receive logic configured to determine when data is pending for the receive port;
functional logic coupled to receive data from the receive port, the functional logic configured to be placed in a low power sleep mode; and
sleep control logic coupled to the functional logic, operable to allow the functional logic to enter the sleep mode while the receive logic indicates no pending data for the receive port and the transmit logic indicates no pending data for the transmit port.

15. The system of claim 14, wherein the receive logic is coupled to storage logic configured to store a sleep/wake value, and wherein when the sleep/wake value is set to a sleep value no data is pending on the receive port, and when the sleep/wake value is set to a wakeup value data may be pending for the receive port.

16. The system of claim 15, wherein the transmit logic in each device is operable to:
transmit a command via the communication bus to another device when no data is pending in the transmit port for the other device, wherein the command causes a sleep value to be stored in the sleep/wake control location of the other device to indicate no pending traffic for the receive port of the other device.

17. The system of claim 15, wherein together the receive logic and sleep control logic are operable to:
receive a command to store a wake value in the sleep/wake storage location via an atomic transaction on the communication bus to indicate pending data for the receive port;
wake the functional logic from sleep mode; and
respond to the atomic transaction with a reply command to indicate the receive port is ready to receive the pending data.

18. The system of claim 14, further comprising address logic coupled to the communication bus, wherein the addressing logic is assigned a logical address for receiving messages from the communication bus, and wherein the address logic retains the assigned logical address when the functional logic enters the sleep mode.

19. The system of claim 14, wherein one or more devices comprise a plurality of receive ports and a plurality of transmit ports, wherein the receive logic is configured to determine when data is pending on any of the plurality of receive ports, wherein the transmit logic is configured to determine when data is pending for any of the plurality of transmit ports, and wherein the sleep control logic is operable to allow the functional logic to enter sleep mode only while the receive logic indicates no pending data for any of the receive ports and the transmit logic indicates no pending data for any of the transmit ports.

20. The system of claim 14 being a cellular phone.
